(19) United States
(12) Patent Application Publication
(10) Pub. No.: US 2014/0375634 A1
(43) Pub. Date: Dec. 25, 2014

(54) HYBRID CLIENT-SERVER RENDERING WITH LOW LATENCY IN VIEW

(71) Applicant: Advanced Micro Devices, Inc., Sunnyvale, CA (US)

(72) Inventors: Karl E. HILLESLAND, San Carlos, CA (US); Christopher J. Brennan, Holden, MA (US); Jason C. Yang, Sunnyvale, CA (US)

(73) Assignee: Advanced Micro Devices, Inc., Sunnyvale, CA (US)

(21) Appl. No.: 14/049,293

(22) Filed: Oct. 9, 2013

Related U.S. Application Data
(60) Provisional application No. 61/839,335, filed on Jun. 25, 2013.

(51) Int. Cl. G06T 17/00; G06T 15/00; G06T 15/80

(52) U.S. Cl. CPC G06T 17/00; G06T 15/80; G06T 15/005
USPC 345/420

(57) ABSTRACT

A method, system and computer-readable medium for rendering images are provided. The method includes rendering a first image based on a model. The method further includes receiving additional image information rendered by the server and incorporating the additional image information into the first image to create a second image for display. The second image is displayed in an output device.

### BACKGROUND

1. Field

Embodiments relate, in general, to computer graphics rendering and, in particular, to real-time 3D graphics rendering in clients and servers.

2. Background

The synthesis of computer graphics for display, also known as rendering, can involve large amounts of computation. For certain real-time applications, such as video games, simulations, etc., rendering needs to occur at very fast speeds. In particular, applications may need to maintain the latency between a user input and the rendering of the corresponding graphics within desirable limits. For example, a high rendering latency in response to a user input in a 3D computer simulations can lead to degraded visual acuity and performance, “simulator sickness,” and breaks in perceived presence.

Rendering for real-time applications has traditionally been limited by the computational capabilities of user devices. However, advances in computer networking and the dramatic increases in available network bandwidth have allowed the possibility of offloading rendering computations from client devices to remote servers, which can stream rendered graphics to the client. Under such a remote or “cloud” rendering scheme, a client may transmit input commands over a network and a server can perform rendering of a scene based on the input and transmit the rendered scene back to the client. However, even with increased network bandwidth, maintaining low latency in cloud rendering systems remains challenging.

### BRIEF SUMMARY OF EMBODIMENTS

As a result, it would be desirable to provide improved approaches at decreasing latency in real-time cloud rendering systems by splitting the rendering computations between a client and a server.

A method, system and computer-readable medium for rendering images are provided in certain embodiments of the present invention. The method includes rendering a first image based on a model. The method further includes receiving additional image information rendered by a server and incorporating the additional image information into the first image (thus modifying the first image) to create a second image for display. The second image is displayed in an output device.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 is a block diagram of an illustrative computing environment, according to an embodiment.

FIG. 2 depicts a flowchart illustrating an exemplary operation of a client in a hybrid client-server rendering system, according to an embodiment.

FIG. 3 depicts a representation of an illustrative 3D environment rendered in a hybrid client-server rendering system, according to an embodiment.

FIG. 4 illustrates the rendering of a 3D environment as a result of changes in the environment or viewpoint, according to an embodiment.

FIG. 5 is an illustration of an example computer system in which embodiments, or portions thereof, can be implemented as computer-readable code.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

In general, rendering involves the process of generating an image from a model by means of a computer. A model can be information that describes a scene. The information can be stored in a specified data representation format, and can include information describing a scene such as, by way of example, the geometry, viewpoint, texture, lighting, shading, etc. A rendering can be a projection of a 3D model onto a 2D viewpoint.

A model can be changing and being constantly recomputed based on events, inputs and simulation results. For example, in video games and simulations, a user may control the viewpoint or interact with objects in the 3D model. These applications can require the real-time rendering of the model as it changes.

In some cases, a client can interact with a model that's located on a remote server. For example, clients with limited computational capabilities (e.g., mobile devices) can benefit from the computational power of a remote server. A model can be stored at a server and the rendering of images can be performed at a server, which can communicate the result of the rendering to the client. However, for real-time remote rendering to be feasible, the server should be able to render the images and communicate them to the client fast enough to maintain low latency between user input and the visual response.

If all rendering is done at the server side, the client must transmit an input to the server and wait for the server to render the images and transmit the images back to the client. This can result in substantial delays, and may require a network connection with high bandwidth and low latency.

In certain embodiments, a client and a server may split the rendering load, with the client rendering certain portions of the model and the server rendering others. A client may lender the basic details of a model which may require less computation, and the server can compute other more computationally intensive details. In other embodiments, in response to a user input, the client can render basic details of a model and transmit the input to the server for computing the more computationally intensive details. In this way, a client may reduce latency by quickly displaying a locally rendered scene with basic details and later on adding details received from the server.

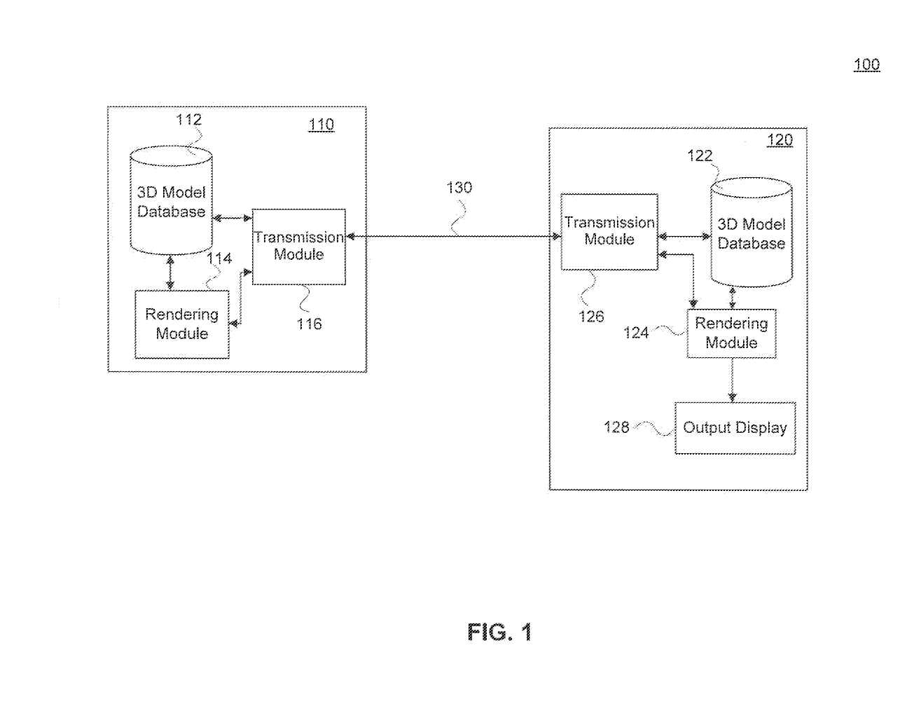

FIG. 1 is a block diagram of an illustrative computing environment 100, according to an embodiment. In one example, operating environment 100 includes a server 110 and a client 120.

Server 110 can be one or more computing systems configured to store and transmit 3D model and rendering information. In an embodiment, server 110 is part of a cloud computing service, such as a collection of computing resources available over a network. In an embodiment, server 110 is a part of a local machine that provides greater computational capability. For example, server 110 can be a discrete Graphical Processing Unit (GPU) inside a client 120.

In one example, client 120 can be a computing device, system, and apparatus, such as a personal computer (PC), laptop, mobile device, phone, tablet, etc. In an embodiment, client 120 can be a web browser with a limited graphics Application Programming Interface (API).

In an embodiment, server 110 and client 120 communicate over channel 130. Channel 130 can be a network, such as a LAN, WAN, wireless network, the Internet, etc. In an embodiment, server 110 and client 120 can be connected directly as parts of a single system, and channel 130 can be a direct connection between server and client. For example, server 110 can be a GPU inside a client 120, and channel 130 can be a bus inside client 120. Other examples within the scope and spirit of these embodiments will be recognized by those skilled in the relevant arts.

In an embodiment, server 110 includes a 3D model database 112, a rendering module 114 and a transmission module 116.

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

Model database 112 can store 3D model data for one or more 3D models. The 3D models can be represented in any data format as will be understood by those skilled in the relevant arts. In an embodiment, the 3D model data can include environment data and lighting data.

Rendering module 114 can include processing capabilities for interpreting 3D model data and creating an output visualization based on the 3D data. For example, rendering module 114 can obtain 3D model data along with point-of-view information and synthesize a 2D image describing the 3D model from the point of view. The process of generating an image from a 3D model is also known as “rendering.” For example, in a computer generated 3D environment (e.g., a video game, 3D simulation, etc.) a user can navigate around a virtual environment using input commands that can indicate a direction of viewing or moving within the environment. In an embodiment, rendering module 114 can generate a 2D projection of a 3D model from the viewpoint of the user. This projection can be called an “eye ray.”

In synthesizing an image, rendering module 114 can simulate how light bounces from objects in a scene onto the viewer's eye. The interaction of light and the environment can include simulating effects such as shadows, shading, direct and indirect lights and reflections, also known as lighting effects. In an embodiment, rendering module 114 separately renders the environment and the lighting effects. For example, rendering module 114 can render lighting effects while allowing the rendering of the environment to occur at a client.

Transmission module 116 can transmit and receive information for generating a view of a 3D model to client 110. Transmission module 116 can transmit information including any combination of 3D model data and rendered image data. Additionally, transmission module 116 can receive information including viewpoint information for generating a view of a 3D model. In an embodiment, transmission module 116 can receives viewpoint information from the client. Transmission module 116 can then communicate a 3D model and rendered lighting effects data to the client. In another example, the clients can locally perform rendering of the environment using the received 3D model and further receive rendered lighting effects from server 120 and combine both to generate the fully rendered image. In such an example the client can avoid spending the computing resources required to render lighting effects.

In an embodiment, client 120 can include a 3D model database 122, a rendering module 124, a transmission module 126 and an output display 128.

Client 3D model database 122 can store 3D model data for one or more 3D models. In an embodiment, client database 122 can store 3D models, or portions thereof, received from server 110. In an embodiment, client database 122 can store 3D model data to render the environment portion of a 3D model.

In an embodiment, rendering module 124 can include processing capabilities for interpreting 3D model data and creating an output visualization based on the 3D data. In an embodiment, client rendering module 124 renders the environment portion of a 3D model stored in database 122.

Client transmission module 126 can transmit and receive information for generating a view of a 3D model in client 120. In an embodiment, client transmission module 126 receives a 3D model from server 110 and receives rendered lighting effects data from server 110.

Client output display can display a rendered image at the client. In an embodiment, the rendering module communicates the completed image to the output display.

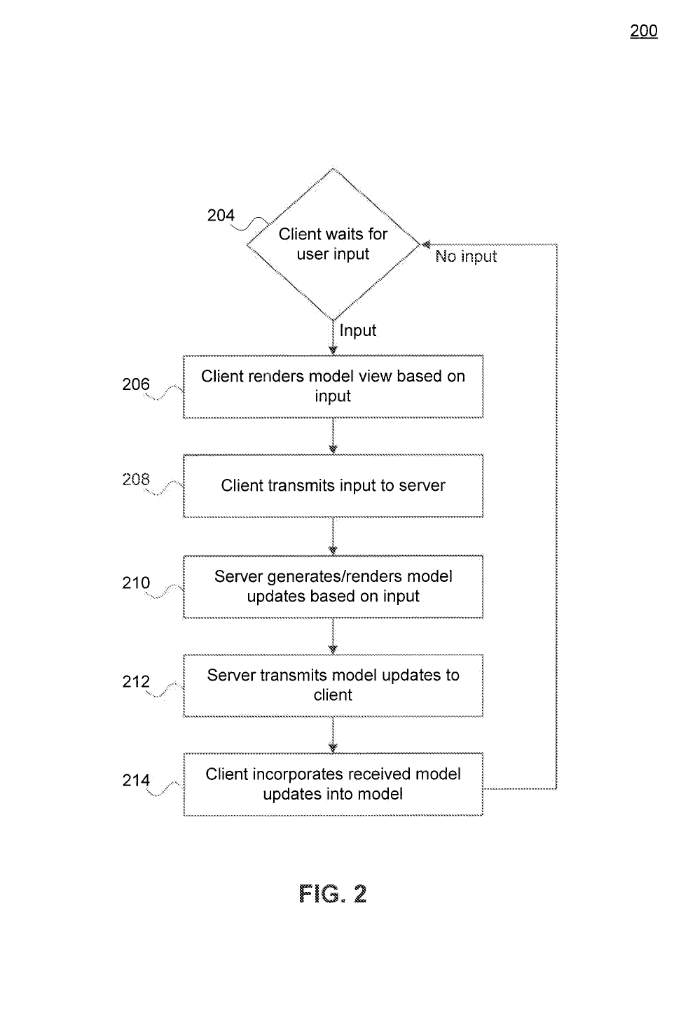

FIG. 2 depicts a flowchart 200 illustrating an exemplary operation of a client in a hybrid client-server rendering system, according to an embodiment. It should be appreciated that the steps in flowchart 200 may occur in the order shown and not all steps need be performed.

At step 202, a server transmits a 3D model to a client. Alternatively, the client could transmit a 3D model that is to be used to a server. However, as shown in the embodiment of FIG. 2, the server transmits 3D model information including environment data. In another embodiment, the server transmits both environment and lighting data. The server can transmit 3D model information to multiple clients.

At step 204, the client waits for input data. Input data can be commands communicated by a user using an input device to navigate a viewpoint of a 3D environment. In certain embodiments, the input comes from simulation events or from network transmissions received at the client. In an alternative embodiment, the input comes from the server or from another device (such as another client and/or another user). As those skilled in the relevant arts will appreciate, the input can be any type of computer input.

At step 206, the client renders an environment based on the received user input. For example, the client can render the environment of a view in a direction based on the commands entered by a user input. In an embodiment, the environment rendered by the client includes the portions dependent on the user viewpoint. In an embodiment, the client initiates this rendering using local computing resources, yielding a low latency rendering response of the environment for display at the client. In an embodiment, the client does not render lighting effects.

At step 208, the client transmits the input to the server. In various embodiments, step 208 can occur before, simultaneously or after step 206. In an alternative embodiment, the server receives the input from another source or generates the input itself. In such an alternative embodiment, the client does not transmit the input to the server.

At step 210, the server renders lighting effects based on the user input. At this step, the server takes the user input, determines the viewpoint that needs to be rendered and calculates the lighting effects for the view. In an embodiment, the server generates video frames containing the lighting effects for the viewpoint. In an alternative embodiment, the server generates data that allows a client to display rendered lighting effects on a display. For example, the server can generate updates to the 3D model that include the lighting effects. The server can then transmit either the entire 3D model or the updates to the client, as detailed in step 212.

The lighting effects computed at step 210 can include the portion of a rendering that depends on the lighting environment. These portions can include any light dependent calculations such as, by way of example, generation of light maps, virtual point lights, photon maps, light probes, and any other light caching mechanisms that are typically computed as a preprocess or at runtime. In an embodiment, these portions can be computed dynamically on the server using available computing resources. In an embodiment, the server shares the rendered lighting data across multiple clients and viewpoints.

In another embodiment, the server computes updated lighting effects based on changes to the lighting environment such as, for example, a light source changing or moving. In an embodiment, the server communicates updated lighting effects to the client as, for example, a pushed update or in response to a request from the client.

At step 212, the server transmits the rendered lighting effects to the client. In an embodiment, the server can transmit video frames containing the lighting effects to the client. In an alternative embodiment, the server transmits an updated 3D model or updates to the client's 3D model that contain the lighting effects. In an embodiment, the server can transmit the rendered lighting effects to multiple clients. In an embodiment, the server uses a hardware on-chip video encoder and the client uses a hardware on-chip video decoder to quickly stream the lighting effects data. In an embodiment, the server streams the data in Partially Resident Texture (“PRT”) tiles, using a prior value as a reference frame for compression, as will be understood by those skilled in the relevant arts.

At step 214, the client incorporates the rendered lighting effects into the client-rendered environment image. In an embodiment, the client updates its local model with the lighting effects information. In an embodiment, the client receives the lighting effects in rendered form and incorporates them into a rendered environment. In an embodiment, the client incorporates lighting effects to a rendered frame.

The client and server can use any data representation for the environment and lighting that will be recognized by those skilled in the relevant arts. In an embodiment, the client and server generate a shadow map from the view of the light, as will be understood by those skilled in the relevant arts. In an embodiment, the client and server store shading information in textures parameterized on the object, or per vertex. In an embodiment, the client or server maintain imposters or view dependent fixtures, such as renderings from fixed viewpoints that can include depth for warping to a specific viewpoint or light position on the client, as will be understood by those skilled in the relevant arts.

In an embodiment, a client or server can use GPU hardware features, such as the AMD “Partially Resident Texture” feature included in Radeon ID 7970 and other products from Advanced Micro Devices, Inc. of Sunnyvale, Calif. to store the currently needed, texture-space tiles of lighting or shadow map information. In an embodiment, this hardware feature is used to identify new regions that need to be updated in an on-demand manner.

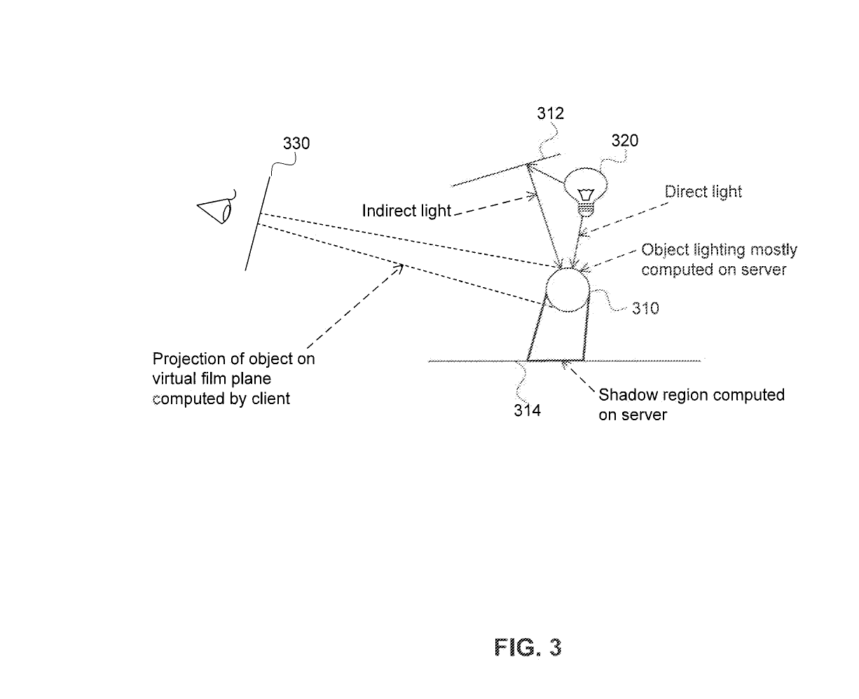

FIG. 3 depicts a representation of an illustrative 3D environment 300 rendered in a hybrid client-server rendering system, according to an embodiment.

3D environment 300 includes an object 310, surfaces 312 and 314, a light source 320 and a viewpoint 330.

Object 310 can be an object described in a data representation of the 3D environment. The data representation for the object can include information about, for example, the object's location, size, shape, color, texture, etc.

Surfaces 312 and 314 can be surfaces described in a data representation of the 3D environment. The data representation for the surface can include information about, for example, the surface's location, orientation, size, color, texture, reflectivity, etc.

Light source 320 can be a source of light described in a data representation of the 3D environment. The data representation for the light source can include information about, for example, the light's location, direction, color, intensity, etc.

Viewpoint 330 can be a rendered point of view, as described above. In an embodiment, the size and direction of viewpoint 330 can be specified, for example, by a user input. Object 310 and surfaces 312 and 314 can be projected onto a rendering of viewpoint 110. A rendering module can project the effects of light source 320 onto a rendered viewpoint 110.

The rays extending from object 310 onto viewpoint 330 illustrate the projection of the object onto the viewpoint. As explained above, the client can generate the projection, since it is dependent on the viewpoint.

The rays extending from light source 320 onto object 310 and surface 312 illustrate the light bouncing off the object and surface. A rendering module can project the lighting of object 310 and surfaces 312 and 314 onto the rendered viewpoint. As explained above, the server can perform the rendering of these lighting effects, since they are dependent on the lighting.

The lines extending from object 310 onto surface 314 illustrate the shadow generated by the object and light source 320. Again, the server can render this shadow, since it is a lighting effect.

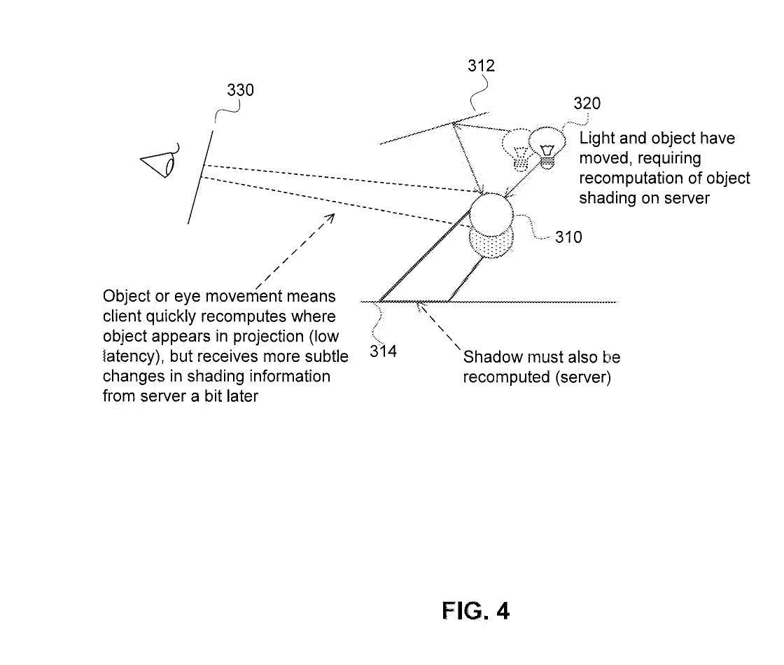

FIG. 4 illustrates the rendering of 3D environment 300 when changes in the environment or viewpoint occur, according to an embodiment.

As an example, object 310 can move from one position to another, as illustrated in FIG. 4. In such an example, a client can render a projection of the object in the new position, as discussed above with reference to FIG. 2. Furthermore, in such an example, the server can compute the rendering for the changes in the shading, the shadow and other lighting effects on the object as a result of the object's new position. The client can thus quickly recompute and display the object's updated position with low latency, and receive more subtle changes in shading information from the server a little bit later.

In another example, light source 320 can move from one position to another, as also illustrated in FIG. 4. In such an example, the server can compute the rendering for the changes in the shading, the shadow and other lighting effects on object 310 and surfaces 312 and 314 as a result of the light source's new position.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the present embodiments. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

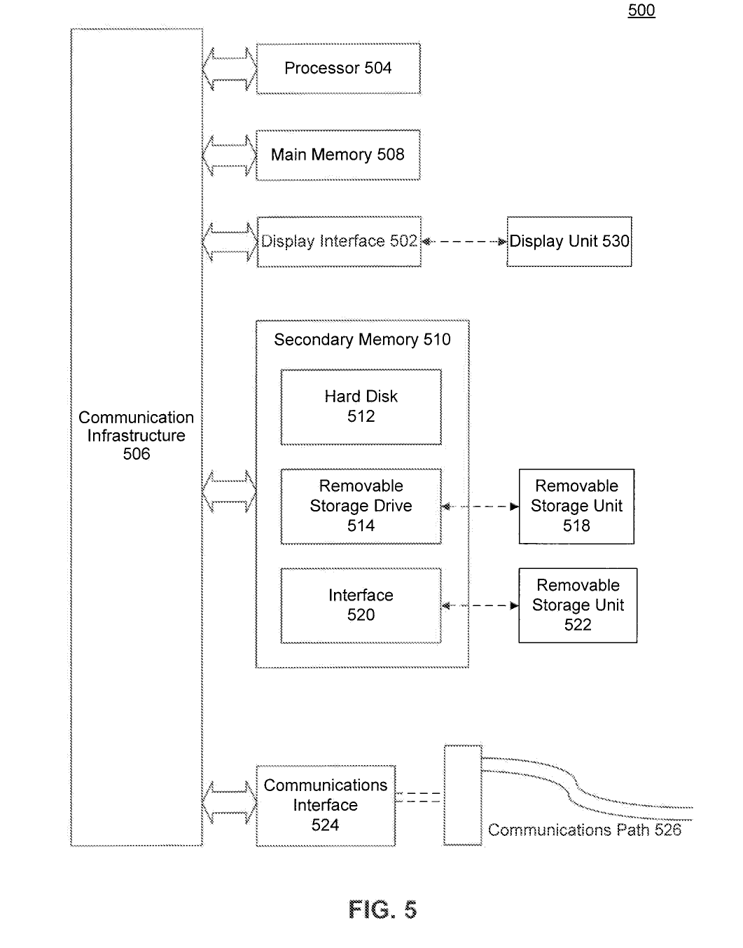

Various aspects of embodiments of the present embodiments may be implemented in software, firmware, hardware, or a combination thereof. FIG. 5 is an illustration of an example computer system 500 in which embodiments, or portions thereof, can be implemented as computer-readable code. For example, the methods illustrated in the present disclosure can be implemented in portions system 500. Various embodiments are described in terms of this example computer system 500. After reading this description, it will become apparent to a person skilled in the relevant art how to implement embodiments using other computer systems and/or computer architectures.

It should be noted that the simulation, synthesis and/or manufacture of various embodiments may be accomplished, in part, through the use of computer readable code, including general programming languages (such as C or C++), hardware description languages (HDL) such as, for example, Verilog HDL, VHDL, Altera HDL (AHDL), other available programming and/or schematic capture tools (such as circuit capture tools), or hardware-level instructions implementing higher-level machine code instructions (e.g., microcode). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core (e.g., a CPU core) that is embodied in program code and can be transformed to hardware as part of the production of integrated circuits.

Computer system 500 includes one or more processors, such as processor 504. Processor 504 may be a special purpose or a general-purpose processor. For example, in an embodiment, CPU 110 of FIG. 1 may serve the function of processor 504. Processor 504 is connected to a communication infrastructure 506 (e.g., a bus or network).

Computer system 500 also includes a main memory 508, preferably random access memory (RAM), and may also include a secondary memory 510. Secondary memory 510 can include, for example, a hard disk drive 512, a removable storage drive 514, and/or a memory stick. Removable storage drive 514 can include a floppy disk drive, a magnetic tape drive, an optical disk drive, a flash memory, or the like. The removable storage drive 514 reads from and/or writes to a removable storage unit 518 in a well-known manner. Removable storage unit 518 can comprise a floppy disk, magnetic tape, optical disk, etc. which is read by and written to by removable storage drive 514. As will be appreciated by persons skilled in the relevant art, removable storage unit 518 includes a computer-usable storage medium having stored therein computer software and/or data.

In alternative implementations, secondary memory 510 can include other similar devices for allowing computer programs or other instructions to be loaded into computer system 500. Such devices can include, for example, a removable storage unit 522 and an interface 520. Examples of such devices can include a program cartridge and cartridge interface (such as those found in video game devices), a removable memory chip (e.g., EPROM or PROM) and associated socket, and other removable storage units 522 and interfaces 520 which allow software and data to be transferred from the removable storage unit 522 to computer system 500.

Computer system 500 can also include a communications interface 524. Communications interface 524 allows software and data to be transferred between computer system 500 and external devices. Communications interface 524 can include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and can be implemented using wire or cable, fiber optics, a phone line, a cellular phone link, a RF link or other communications channels.

In this document, the terms “computer program medium” and “computer-usable medium” are used to generally refer to media such as removable storage unit 518, removable storage unit 522, and a hard disk installed in hard disk drive 512. Computer program medium and computer-usable medium can also refer to memories, such as main memory 508 and secondary memory 510, which can be memory semiconductors (e.g., DRAMs, etc.). These computer program products provide software to computer system 500.

Computer programs (also called computer control logic) are stored in main memory 508 and/or secondary memory 510. Computer programs may also be received via communications interface 524. Such computer programs, when executed, enable computer system 500 to implement embodiments as discussed herein. In particular, the computer programs, when executed, enable processor 504 to implement processes of embodiments, such as the steps in the methods illustrated by the flowcharts of the figures discussed above. Accordingly, such computer programs represent controllers of the computer system 500. Where embodiments are implemented using software, the software can be stored in a computer program product and loaded into computer system 500 using removable storage drive 514, interface 520, hard drive 512, or communications interface 524.

Embodiments are also directed to computer program products including software stored on any computer-usable medium. Such software, when executed in one or more data processing device, causes a data processing device(s) to operate as described herein. Embodiments employ an computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

What is claimed is:

1. A computer-implemented method of rendering comprising:
rendering a first image, the first image being based on a model;
receiving additional image rendering information from a server;
incorporating the additional image rendering information into the first image to create a second image; and
outputting the second image on an output device.

2. The method of claim 1, further comprising:
receiving an input from a user;
transmitting the input to the server.

3. The method of claim 1, wherein the first and second images comprise a rendered three-dimensional environment.

4. The method of claim 1, wherein the first image comprises a rendering of an environment described in the model.

5. The method of claim 1, wherein the additional image rendering information comprises lighting effects described in the model.

6. The method of claim 1, wherein the input comprises an instruction to change a viewpoint associated with the model.

7. The method of claim 1, wherein the input comprises an instruction to change an object in the model.

8. A computer-implemented method of rendering comprising:
rendering lighting effects, the lighting effects being based on a model; and
transmitting the lighting effects to the client device.

9. The method of claim 8, further comprising:
receiving an input from a client device.

10. The method of claim 8, further comprising representing the lighting effects in a format suitable for incorporating the effects into a rendered three-dimensional environment.

11. A system comprising:
a processor;
a memory configured to store information that causes the processor to perform operations comprising:
rendering a first image, the first image being based on a model;
receiving additional image rendering information from the server;
incorporating the additional image rendering information into the first image to create a second image; and
outputting the second image on an output device.

12. The system of claim 11, further comprising:
receiving an input from a user;
transmitting the input to the server.

13. The system of claim 11, wherein the first and second images comprise a rendered three-dimensional environment.

14. The system of claim 11, wherein the first image comprises a rendering of an environment described in the model.

15. The system of claim 11, wherein the additional image rendering information comprises lighting effects described in the model.

16. The system of claim 11, wherein the input comprises an instruction to change a viewpoint associated with the model.

17. The system of claim 11, wherein the input comprises an instruction to change an object in the model.

18. A computer-readable storage medium having instructions stored thereon, execution of which by a processor cause the processor to perform operations, the operations comprising:
rendering a first image, the first image based on the input and a model;
receiving additional image rendering information from the server;
incorporating the additional image rendering information into the first image to create a second image; and
outputting the second image on an output device.

19. The computer-readable storage medium of claim 18, further comprising:
receiving an input from a user;
transmitting the input to the server.

20. The computer-readable storage medium of claim 18, wherein the first and second images comprise a rendered three-dimensional environment.

21. The computer-readable storage medium of claim 18, wherein the first image comprises a rendering of an environment described in the model.

22. The computer-readable storage medium of claim 18, wherein the additional image rendering information comprises lighting effects described in the model.

23. The computer-readable storage medium of claim 18, wherein the input comprises an instruction to change a viewpoint associated with the model.

24. The computer-readable storage medium of claim 18, wherein the input comprises an instruction to change an object in the model.
